(19) United States
(12) Patent Application Publication
(10) Pub. No.: US 2018/0207700 A1
(43) Pub. Date: Jul. 26, 2018

(54) STRAIGHTENING BENCH FOR VEHICLE CHASSIS AND BODY, AND KITS FOR ANCHORING TO A VEHICLE CHASSIS

(71) Applicant: CARROSSERIE TECHNIC, Cuesmes (BE)

(72) Inventor: Haydar SERBES, Binche (BE)

(73) Assignee: CARROSSERIE TECHNIC, Cuesmes (BE)

(21) Appl. No.: 15/745,575

(22) PCT Filed: Jul. 19, 2016
(86) PCT No.: PCT/EP2016/067147

§ 371 Date: Jan. 17, 2018

(30) Foreign Application Priority Data
Jul. 20, 2015 (EP) 15177453.6
Mar. 18, 2016 (BE) 2016/5195

(51) Int. Cl. B21D 1/14; B66F 7/12; B66F 7/28

(52) U.S. Cl. CPC B21D 1/145; B66F 7/28; B66F 7/12; B21D 1/14

(57) ABSTRACT

The invention relates to a straightening bench for a vehicle chassis and body, characterised in that it comprises: a vehicle lift with four beams, including two longitudinal beams and two crossbeams interconnected in pairs, each of the two crossbeams being linked to two lifting columns. Also disclosed are means for fastening the vehicle to the longitudinal beams of the straightening bench, these fastening means being capable of attaching a vehicle resting on its wheels to the longitudinal beams.

### DOMAIN OF THE INVENTION

The invention relates to a straightening bench for a vehicle chassis and body. The invention also relates to fastening means to fix the vehicle to a straightening bench.

### STATE OF PRIOR ART

The known document U.S. Pat. No. 7,076,988 discloses a straightening bench for a vehicle chassis and body comprising a straightening table and a straightening beam. The straightening table is fitted on a scissors elevator. Once the vehicle is in position on the straightening table and is fixed to it, the scissors elevator can raise the vehicle so that the straightening work can be done. In such an apparatus, once the vehicle has been lifted it is no longer on its wheels, which limits use of the apparatus to straightening operations only. Measurement of the vehicle chassis to evaluate progress of the straightening work requires that the vehicle is moved onto another apparatus in which the vehicle is placed on its wheels.

Document WO2009/095533 is also known that describes a straightening bench comprising a scissors elevator and also planes on which vehicle wheels can be supported once the vehicle is raised. Therefore in such an apparatus, the vehicle can be supported on its wheels once it is raised and work other than straightening of the chassis and the body can be done on the vehicle. However, the presence of the scissors elevator under the straightening table limits the possibilities of work on the vehicle and occupies space that make it impossible to use some instruments such as ultrasound chassis measurement instruments that require the use of a straight edge under the vehicle.

### SUMMARY OF THE INVENTION

One purpose of the invention is to use a straightening bench to perform straightening operations themselves and also to measure the effect of said straightening operations on the vehicle chassis without needing to move the vehicle.

Another purpose of the invention is to provide an apparatus on which any type of work can be done on a vehicle: straightening the vehicle, mechanical work, adjustment of headlights, measurement of the chassis and geometry of the vehicle.

To achieve this, the straightening bench for the chassis and the body of a vehicle according to the invention comprises:

An elevating platform comprising four beams, said four beams comprising two longitudinal beams and two cross beams connected in pairs, each of the two cross beams being connected to two lifting columns,

Means of fastening the vehicle to the longitudinal beams of the straightening bench, said attachment means being capable of fixing a vehicle placed on its wheels on said longitudinal beams.

According to one advantageous embodiment, the fastening means of the straightening bench according to the invention can be fixed to the main beams or the main beam stiffeners of the vehicle, also called underbody rabbets.

According to one advantageous embodiment, the attachment means comprise fasteners with a degree of freedom for vertical adjustment to adapt to the height of the main beams or main beams stiffeners of different vehicle models. According to one advantageous embodiment, said fasteners comprise a degree of freedom for horizontal adjustment to adapt to the spacing between (stiffeners of) the left and right main beams of different vehicle models.

Therefore the straightening bench according to the invention can be used as a conventional elevating platform with four columns once the vehicle wheels are placed on the longitudinal beams. This makes it possible to perform all types of mechanical work, given that the mechanic has an optimum work space under the vehicle once the vehicle has been elevated using the elevating columns of the apparatus.

According to one embodiment, the straightening bench includes at least one straightening bracket, said straightening bracket being attached to one of said four beams.

The presence of the straightening bracket and the means of fastening the vehicle to the straightening bench can also be used for straightening work of the chassis and the body expected from a classical straightening bench, by means of chains or cables attached to the straightening bracket. However, in a straightening bench according to the invention, the vehicle will remain on its wheels at all times, unlike straightening benches disclosed in prior art. This latter characteristic makes it possible to include vehicle wheel and headlight adjustment devices into the straightening bench according to the invention. These devices cannot be used unless the vehicle is supported on its wheels.

Moreover, the work space released under the vehicle, once the vehicle has been elevated, makes it possible to install an ultrasound chassis measurement instrument. In this way, the vehicle chassis can be straightened and measured concomitantly, without needing to move the vehicle to another apparatus.

Consequently, the straightening bench according to the invention can be used to make multiple tasks at the same location, without moving the vehicle.

According to one advantageous embodiment, the straightening bench according to the invention comprises means of varying the distance between longitudinal beams. Such means advantageously include rails on cross beams on which the longitudinal beams can slide.

This embodiment advantageously makes it possible to adjust the space between the longitudinal beams to suit the dimensions of the vehicle to be repaired. Thus, vehicles with different widths can be repaired on the same straightening bench.

According to one advantageous embodiment, said straightening bracket is attached to said beam by removable attachment means.

In this embodiment, the straightening bracket can be displaced to different locations on the beams of the straightening bench, so that it can be displaced as a function of the zones of the chassis or the body to be straightened.

According to one advantageous embodiment, the beams of the straightening bench according to the invention are I-beams, the central part of said beams being sufficiently wide so that a tyre of said vehicle can roll and the lateral parts being perforated with holes at regular intervals.

In this embodiment, the holes form practical attachment means for the straightening brackets and for any other tools or instruments to be used in combination with the straightening bench.

According to one advantageous embodiment, the removable attachment means of the straightening bracket comprise rods inserted in the holes of one of said I-beams.

According to one advantageous embodiment, rails are fixed on said I-beams, the straightening brackets being capable of sliding on said rails.

In this embodiment, the straightening brackets can be displaced along the beams of the straightening bench and therefore must be positioned optimally depending on the specific nature of the straightening work to be done.

According to one advantageous embodiment, the straightening bench according to the invention comprises a hydraulic ram fixed on one of said four beams, said ram being capable of applying a vertical force on a point of the vehicle within the perimeter defined by said four beams.

In this embodiment, said ram can be used as a straightening means, but also to lift the vehicle chassis close to a wheel so as to change said wheel.

According to one advantageous embodiment, the straightening bench according to the invention comprises a straight edge, said straight edge being fixed to at least one of the beams of the straightening bench and acting as a reference line on which a data collection system for a vehicle chassis measurement system can slide.

In general, a vehicle chassis measurement system comprises a data collection device for which there can be a number of different embodiments, for example an ultrasound receiver device to pick up signals emitted by emitters at different locations on the vehicle or a measurement head comprising an orientable arm, the end of which is put into contact with different points on the chassis or the body of the vehicle. The vehicle deformation is evaluated by comparing measurement values collected by the ultrasound receiver device or the measurement head with standard values supplied by the vehicle manufacturer.

Due to its attachment to at least one beam of the straightening bench, said straight edge on which the data collection device can slide is fixed to the reference line composed of the beams of the straightening bench on which the vehicle is placed, so that the measurement system can remain operational when the lifting columns are activated and the height of the straightening bench and therefore the vehicle varies. In this way, straightening work may be done and chassis measurements may be taken concomitantly and in optimum comfort, given that the vehicle height can be adapted at any time depending on the needs of the operator.

According to one advantageous embodiment, said straight edge comprises a beam fixed between said longitudinal beams by means of cross beams connecting the longitudinal beams in pairs.

Therefore this embodiment combines the straightening and chassis measurement functions into a single apparatus, which provides optimum work conditions because the vehicle does not have to be moved onto another apparatus to evaluate the effect of the straightening work. This facilitates use and provides considerable time saving for the body builder.

According to one advantageous embodiment, the straightening bench according to the invention comprises a system for measuring the suspension geometry of the vehicle mounted on said longitudinal beams of the straightening bench. Therefore such a system can be directly integrated into the straightening bench according to the invention because the vehicle is placed on its wheels on the longitudinal beams, which is necessary to measure characteristic angles such as the inclination of pivots, the caster, the camber or the parallelism. Such as system includes plates on which the vehicle wheels fitted with sensors are placed and displaced, in order to make the necessary measurements. Due to the design of the straightening bench according to the invention, the plates of the system for measuring the geometry of the wheels can be integrated into the longitudinal beams on which the vehicle wheels are placed. In this way, straightening tools present on the straightening bench such as straightening brackets can also be used to do work on the suspension geometry of the vehicle and the impact of this work can be measured directly due to the system for measuring the suspension geometry. Such an arrangement will make it possible to use the straightening brackets to work on the suspension geometry of the vehicle and therefore to avoid the need to replace some parts of the vehicle front and rear suspensions. Therefore there will be a saving of equipment and an increase in speed associated with use of the straightening bench according to the invention.

In one particularly advantageous embodiment, the front cross beam of the straightening bench includes a rail on which a measurement tool can be installed for use in adjusting headlights. Once again, it is possible to use such a tool because the vehicle is supported on its wheels. The presence of such a tool will make the straightening tool according to the invention even more versatile.

The innovative approach of the straightening bench according to the invention that consists of keeping the vehicle placed on its wheels under all circumstances makes it possible to perform all types of mechanical work on the vehicle without needing to move the vehicle onto other apparatus. Therefore the straightening bench according to the invention is actually a multi-task apparatus with a design such that a set of tools and instruments that could not be used concomitantly in prior art can all be assembled in a single structure. In particular, the fact that straightening, chassis measurement and suspension geometry measurement tools can all be combined in a single apparatus is particularly advantageous economically due to the saving in time and in equipment, and technically due to the precision obtained for work on the chassis and the suspension geometry of the vehicle, due particularly to the possibility of using straightening brackets to vary the suspension geometry of the vehicle, which has never been done in the past.

In one advantageous embodiment, the attachment means of the straightening bench according to the invention comprise a degree of freedom in rotation about a rotation axis parallel to the plane formed by said four beams. This degree of freedom maintains the attachment of the vehicle to the frame formed by the four beams even when the chassis of the vehicle is raised at a single location and becomes oblique relative to said frame, for example when a wheel of the vehicle has to be changed. The fact that the attachment of the vehicle to the straightening bench can be maintained under all circumstances is particularly useful to avoid the need to repeat the calibration of tools for measurement of the chassis and the suspension geometry of the vehicle. According to one particularly advantageous embodiment, said rotation axis parallel to the plane formed by said four beams is also parallel to the cross beams of the straightening bench.

In one advantageous embodiment, said attachment means of the straightening bench according to the invention comprise a degree of freedom in rotation about a rotation axis perpendicular to the plane formed by said four beams. In such an embodiment, the attachment means may be oriented along the axis of the main beams or the main beam stiffeners of the vehicle to be fixed to the straightening bench. Thus, cars with a streamlined profile and therefore non-parallel right and left main beam stiffeners can be fixed to the straightening bench without difficulty.

Another purpose of the invention is to provide means of attachment of a vehicle to a straightening bench comprising the degrees of freedom in rotation and translation described above, adapted to any type of vehicle body and chassis and also being easily and quickly installed while remaining very reliable.

To achieve this, the attachment to fix a vehicle to a straightening bench according to the invention comprises a rod with a groove machined in it at one end of said rod, said groove dividing the end of said rod into two legs, each of the two legs comprising a through hole, said two through holes facing each other and also comprising a first jaw, said first jaw being inserted in said groove, said first jaw comprising a through hole facing the through holes in the legs of said rod, and a second C-shaped jaw comprising a concave part, one leg of said rod being inserted in the concave part of said jaw, said jaws comprising a plurality of through holes facing each other in pairs, bolts being inserted in said through holes to fix the first jaw to said rod and to fix the second jaw to the first jaw.

Such an attachment has been found to be particularly efficient to be fixed to a vehicle main beam stiffener (underbody rabbet) because said rod can be installed free to rotate on a beam of the straightening bench according to the invention, so that the jaws can be oriented along the axis of the main beam stiffeners of the vehicle to be fixed to the straightening bench. Thus, cars with a streamlined profile and therefore non-parallel right and left main beam stiffeners, can be fixed to a straightening bench using the attachment means according to the invention without any difficulty. Furthermore, the possibility of varying the orientation of the jaws relative to the axis defined by the through holes formed in the two legs of the rod make it possible to maintain the attachment of the vehicle to the straightening bench even when the chassis of the vehicle is raised at a single location. Furthermore, due to the particular design of the attachment according to the invention, said first and second jaws, due to their through holes facing each other, can be brought towards each other while remaining parallel by screwing bolts and nuts, which can maximise the area of the clamping zone and the clamping force between the two jaws and therefore the reliability of the attachment according to the invention. This effect is not observed for attachments according to prior art for which the clamping zone is the result of rotation and not translation of the first and second jaws.

According to a second advantageous embodiment, the attachment rod according to the invention is threaded. Such a thread can make it easy to fasten the rod to a beam of a straightening bench. It will also be possible to adjust the height of said attachment to adapt to the height of the vehicle.

According to one advantageous embodiment, such attachments are fixed to the longitudinal I-beams of the straightening bench according to the invention by means of U-shaped parts in which a hole is formed in their central part to hold the attachment rod according to the invention. If the hole is elongated, said attachments can be fixed with a degree of freedom in translation perpendicular to said longitudinal beams, so as to adapt to the width of the vehicle.

However, such attachments cannot be used directly unless the vehicle is fitted with appropriate main beam stiffeners, in other words that can be firmly gripped by the jaws of the attachment. If there are no such main beam stiffeners, said attachments cannot be used efficiently.

Consequently, another purpose of the invention is to provide means of fixing all vehicle types to the straightening bench.

To achieve this, the anchor kit to the chassis of a vehicle for an attachment for fastening to a straightening bench according to the invention comprises:

at least two rods, each rod comprising an anchor head for a jack support hole in said vehicle;

at least one beam comprising two through holes, the distance (D) between said two through holes being equal to the distance between the support hole of the front jack support and the support hole of the rear jack support of said vehicle, the diameter of said through holes being sufficient to enable passage of said at least two rods;

attachment means to fix said at least one beam to at least two rods anchored to the chassis of the vehicle.

The chassis of a vehicle is generally equipped with holes formed in its main beams, generally protected by caches, designed to hold a jack when a wheel is being changed. Surprisingly, it has been found that these holes can be used differently from their primary function and can be used to attach the vehicle to the straightening bench. These holes are formed in a very strong part of the vehicle chassis and consequently are at an appropriate location for inserting rods fitted with anchor heads.

Anchor heads of the threaded rods must be designed so that they can be inserted in jack support holes while remaining anchored inside these holes once they have been positioned in them. Consequently, the anchor head and therefore the rod must be adapted to the particular model of the vehicle to be fixed to the straightening bench.

The beam advantageously comprises means of varying the distance between said two through holes, so that it can be used for different vehicle models and that therefore have a different spacing distance between their jack support holes.

According to one advantageous embodiment, said at least two rods in the anchor kit are threaded and the attachment means of said rods to the beam include nuts.

In this embodiment, once the head of the threaded rods has been inserted into the vehicle jack support holes, the beam of the anchor kit can be fixed to the vehicle by inserted the threaded rods in the through holes of the beam and fixing them using nuts.

According to another embodiment, the anchor rods have holes formed in them and pins are used to fix said rods to said beam once the anchor heads have been inserted into the jack support holes.

Once the beams have been solidarised to the right and left sides of the vehicle, they can be fixed directly to the straightening bench using the attachments described above.

Therefore the invention relates directly to the use of jack support holes of a vehicle as means of fixing said vehicle to a straightening bench.

The invention is also applicable to another type of kit for anchorage to the chassis of a vehicle comprising a first cross beam dedicated to the front part of the vehicle, a second cross beam dedicated to the rear part of the vehicle, the first beam comprising anchor parts to the chassis of the vehicle, the second beam comprising anchor parts to the chassis of the vehicle, each of said first and second beams comprising a rail, said anchor parts comprising a U-shaped part and a closing plate to fix said anchor parts around said rails by closing said U-shaped parts, said beams also comprising attachment parts comprising a U-shaped part and a closing plate to fix said attachment parts around said rails by closing said U-shaped parts, the attachment parts also comprising a clamping plate that can be clamped by the attachment plates of a straightening bench.

The second type of anchor kit disclosed above is found to be more appropriate than the first described part for some vehicle models.

In one advantageous embodiment, the anchor parts of the first beam are designed so that they can be fixed to the vehicle chassis using screws fixing the front cradle to the vehicle chassis.

In one advantageous embodiment, the anchor parts of the first beam can be fixed to the vehicle chassis using screws fixing the vehicle rear axle to the vehicle chassis.

### BRIEF DESCRIPTION OF THE FIGURES

These aspects and other aspects of the invention will be clarified in the detailed description of particular embodiments of the invention given with reference to the drawings in the figures, among which:

FIG. 1 is an elevation view of one embodiment of the straightening bench according to the invention;

FIG. 2 is a side view of an example embodiment of the straightening bench according to the invention;

FIG. 3 is a view of one embodiment of the attachment for fixing a vehicle to a straightening bench according to the invention;

FIG. 4 is a view of a U-shaped part for fixing the vehicle to the straightening bench;

FIG. 5 is a view of the beam of the anchor kit to the vehicle chassis according to the invention;

FIG. 6 is a rod with an anchor head for the anchor kit to the vehicle chassis according to one embodiment of the invention;

FIG. 7 is a rod with an anchor head for the anchor kit to the vehicle chassis according to another embodiment of the invention;

FIG. 8 is a view of an anchor kit according to another embodiment of the invention;

FIG. 9 is an elevation view of an embodiment of the straightening bench according to the invention comprising a straight edge acting as a reference for a chassis measurement system, plates to measure the suspension geometry and a measurement instrument for adjustment of the headlights;

The figures are not drawn to scale. In general, similar elements are denoted by similar references in the figures.

### DETAILED DESCRIPTION OF PARTICULAR EMBODIMENTS

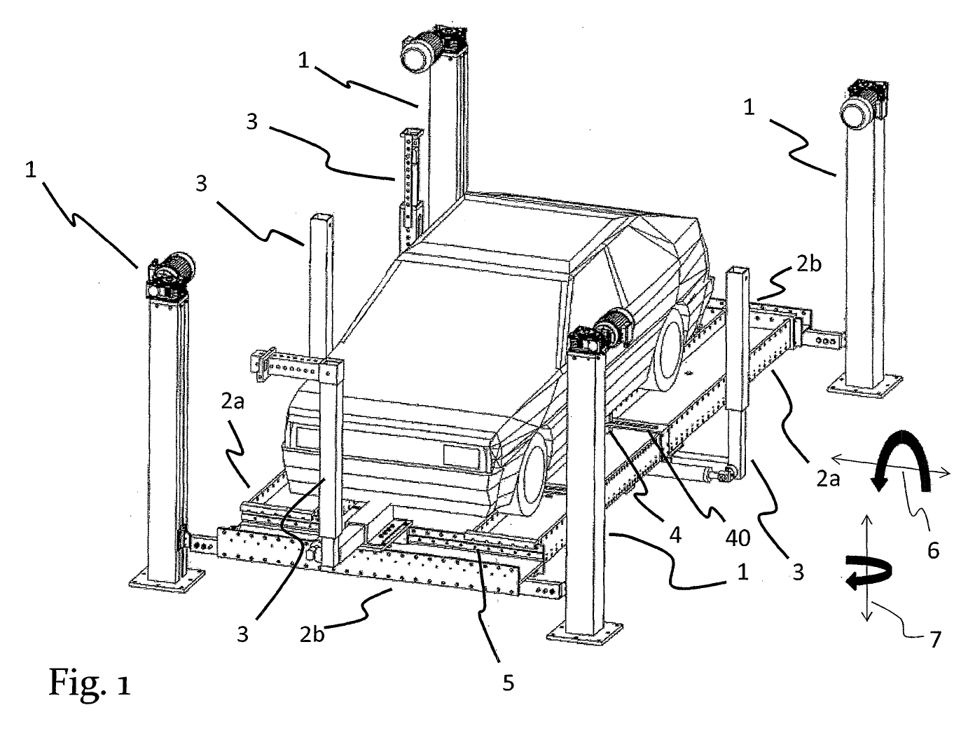

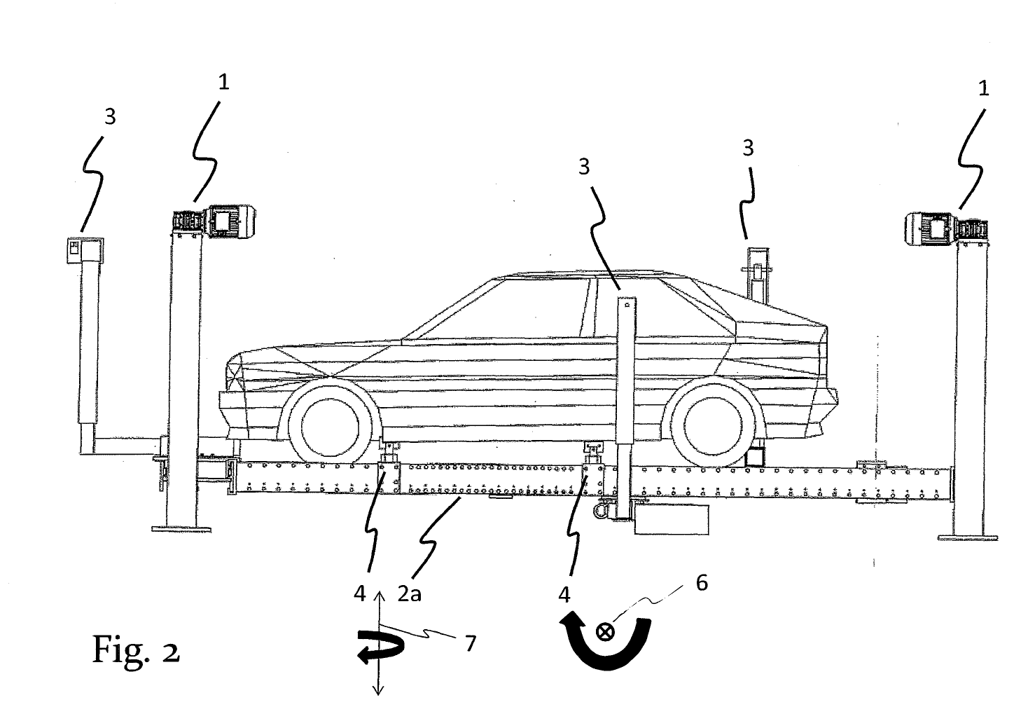

FIG. 1 and FIG. 2 represent one embodiment of the straightening bench according to the invention. The straightening bench comprises four lifting columns 1, two cross beams 2b connected to the lifting columns 1, and two longitudinal beams 2a connected to the cross beams 2b and designed to hold the wheels of the vehicle to be repaired. Attachment means 4 of the vehicle to the longitudinal beams 2a of the straightening bench are present in order to fix the vehicle in place for straightening work. The straightening brackets comprise hydraulic rams to move in three dimensions in space and thus to enable straightening of the chassis or the body once fitted with chains or cables. The longitudinal beams 2a and cross beams 2b of the straightening bench are I-beams. The width of the central part of the longitudinal beams 2a is sufficiently large to support the tyre of the vehicle to be repaired. The lateral parts of the I-beams are provided with through holes formed at regular intervals. Such holes are used for the attachment of U-shaped parts 40 to which the attachments 4 are fitted, and also for the attachment of rails 5 along which the straightening brackets 3 can slide. The lifting columns 1 of the straightening bench are provided with worm screws. Moreover, the longitudinal beams 2a can slide along cross beams 2b, so as to adapt the spacing between the longitudinal beams 2a to the specific width of the vehicle to be repaired. The attachments 4 include a degree of freedom in rotation about a rotation axis 6 parallel to the plane formed by said four beams 2a, 2b. This degree of freedom makes it possible to maintain the attachment of the vehicle to the frame formed by the four beams 2a, 2b even when the vehicle chassis is raised at one location only and becomes oblique relative to said frame, for example when a wheel of the vehicle needs to be changed. For example, the vehicle can be raised in this way by a hydraulic ram fixed to one of said four beams 2a, 2b, said ram being capable of applying a vertical force on a point of the vehicle within the perimeter defined by said four beams 2a, 2b. Attachments 4 also comprise a degree of freedom in rotation about the rotation axis 7 perpendicular to the plane formed by said four beams 2a, 2b. In such an embodiment, the attachment means can be oriented along the axis of the main beams or the main beam stiffeners of the vehicle to be fixed to the straightening bench. Thus, cars with a streamlined profile and therefore non-parallel right and left main beam stiffeners can be fixed to the straightening bench according to the invention without difficulty.

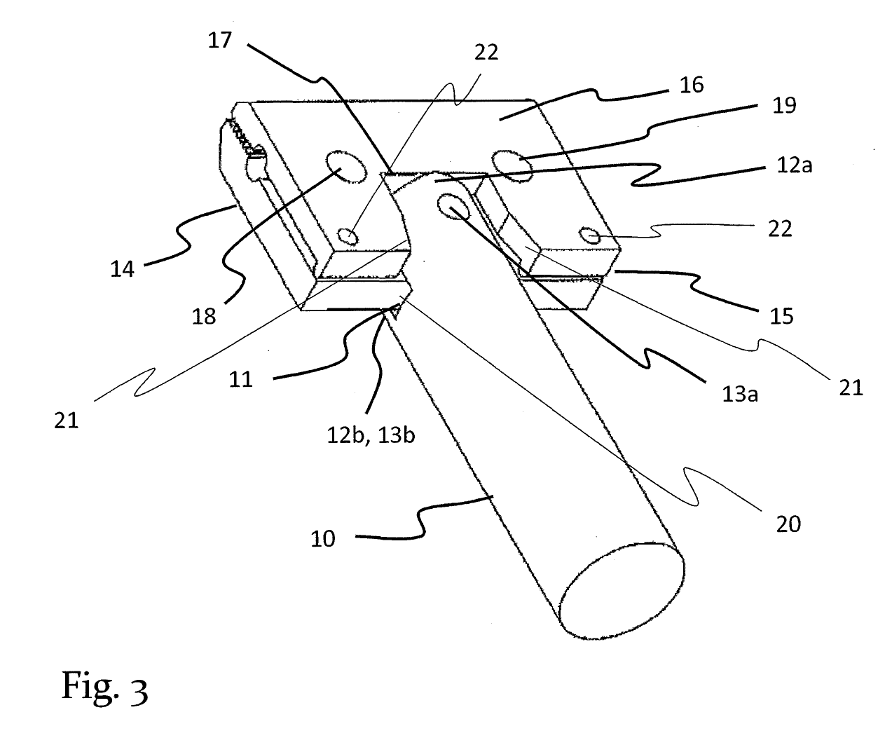

FIG. 3 shows details of an embodiment of the attachment used to fix the vehicle to the straightening bench. The attachment comprises a rod 10 with a groove 11 machined at one of its ends. The groove 11 divides the end of the rod 10 into two legs 12a and 12b, each of the two legs having a through hole 13a and 13b, the two through holes 13a and 13b facing each other.

The attachment also comprises a first jaw 14, said first jaw 14 being inserted in the groove 11 of the rod 10. This first jaw is provided with a through hole 15 facing the through holes 13a and 13b of the legs 12a and 12b of said rod 10. The through holes 13a and 13b of the rod 10 and the hole 15 in the first jaw are used to fix the first jaw to the rod 10, for example using a nut and a bolt with appropriate dimensions (not shown).

The attachment also comprises a second C-shaped jaw 16 comprising a concave part 17, a leg of said rod 12a being inserted in the concave part 17 of the second jaw 16. The jaws 14 and 16 also comprise a plurality of through holes 18 and 19 facing each other in pairs. These through holes 18 and 19 are used to fix the first jaw 14 to the second jaw 16, for example using nuts and bolts with appropriate dimensions (not shown).

Such an attachment is found to be particularly effective for fixing to a main beam stiffener (=underbody rabbet) of a vehicle since said rod can be mounted free to rotate on a beam of the straightening bench beam according to the invention, so that the jaws 14 and 16 can be oriented along the axis of the main beam stiffeners of the vehicle to be fixed to the straightening bench. Thus, cars with a streamlined profile and therefore non-parallel right and left main beam stiffeners can be fixed to a straightening bench without difficulty using attachment means according to the invention. Furthermore, the possibility of varying the orientation of the jaws relative to the axis defined by the through holes 13a and 13b formed in the two legs 12a and 12b of the rod 10 can be used to fix the vehicle to the straightening bench even when the vehicle chassis is raised at a single location. In order to facilitate this rotation, a space 20 is provided on the second jaw between the rod 10 and the first jaw 14 and the chamfers 21.

Furthermore, due to the particular design of the attachment according to the invention and due to their facing through holes 18, 19, said first and second jaws 14 and 16 can be moved towards each other while remaining parallel by screwing of the bolts and nuts, to maximise the area of the clamping zone and the clamping force between the two jaws and therefore the reliability of the fastener according to the invention. This effect is not observed for fasteners according to prior art for which the clamping zone is the result of rotation rather than translation of the first and second jaws. In order to further reinforce this parallelism, advantageously tapped through holes 22 can be present in the first or the second jaw in order to hold threaded rods that push against the opposite jaw until the required parallelism is reached.

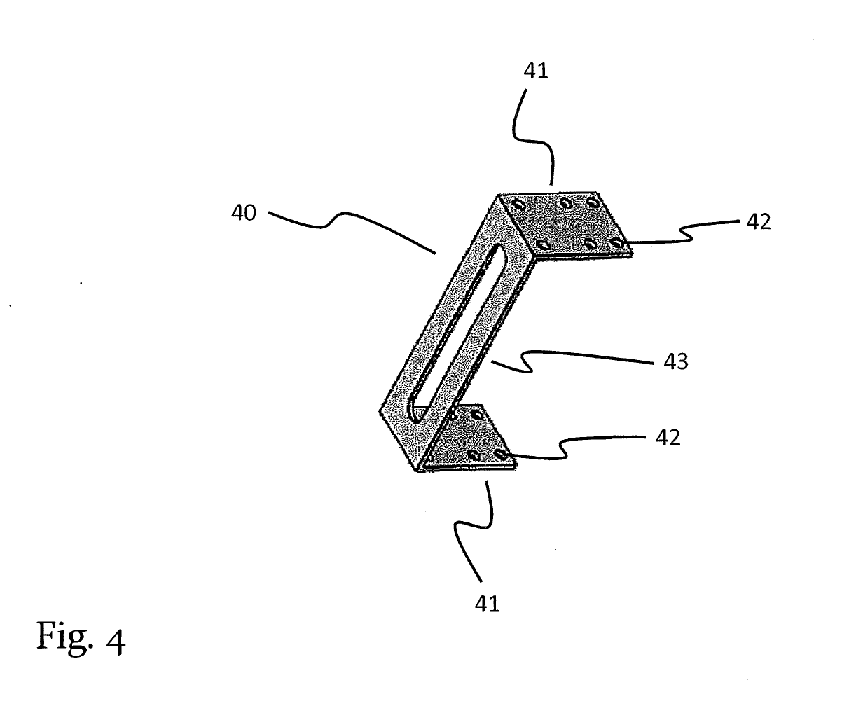

The rod 10 is advantageously threaded (not shown). In this way, it can easily be fixed to an I-beam of the straightening bench according to the invention, at the required height. The U-shaped part 40 represented in FIG. 4 can easily be fixed to the I-beams of the straightening bench according to the invention due to its lateral parts 41 in which through holes 42 are formed. There is a slot formed in the central part 43, that can contain the rod 10 that is fixed to it by a nut. The slot also provides a degree of lateral freedom to fix the rod at the required location.

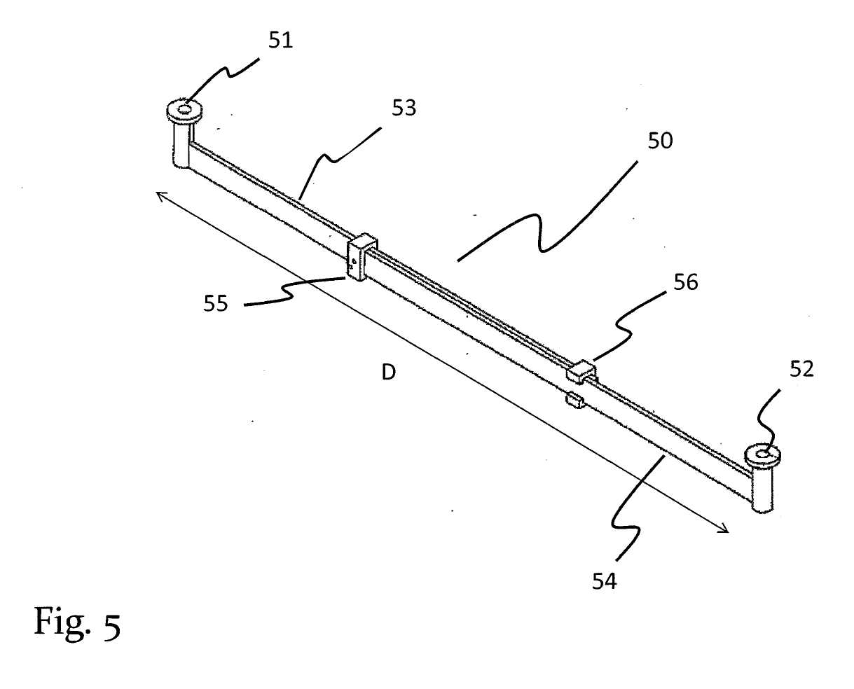

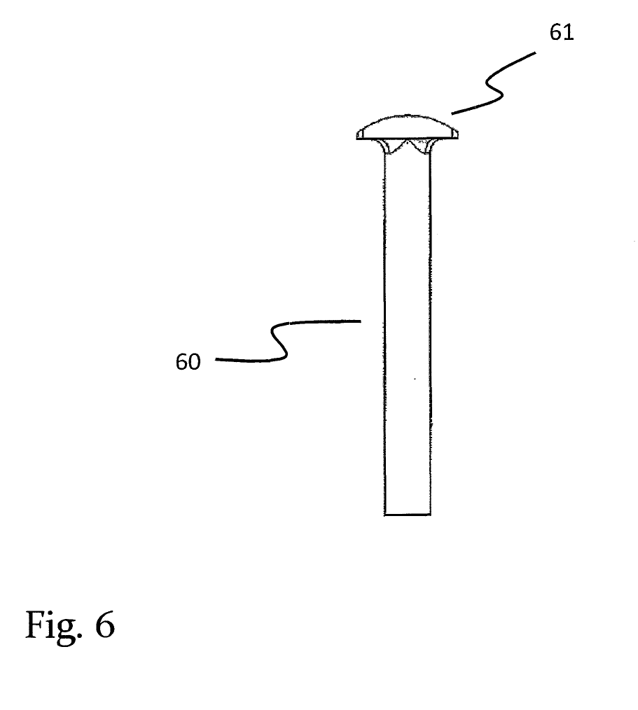

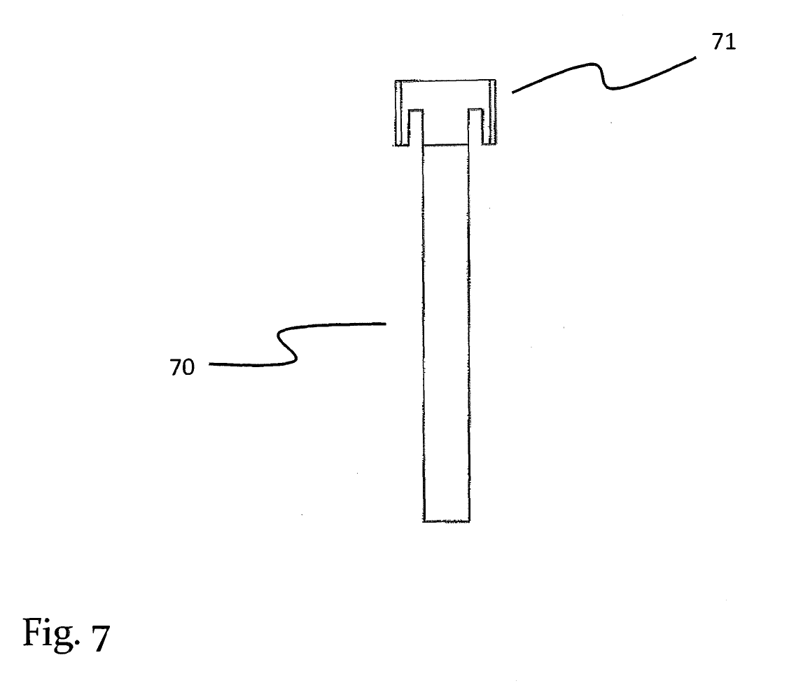

FIG. 5 represents the beam 50 of the anchor kit according to the invention that will cooperate with the anchor rods 60 and 70 represented in FIGS. 6 and 7. Therefore this beam 50 has two holes 51 and 52 formed in it that can hold the anchor rods 60 and 70 after these rods have been inserted in the jack support holes of a vehicle. Therefore the spacing D between the holes 51 and 52 must correspond to the distance between the jack support holes of the vehicle. Considering that this distance varies from one vehicle model to another, the beam 50 in the anchor kit according to the invention advantageously comprises means of varying the distance between the through holes 51 and 52. In the embodiment represented in FIG. 5, the beam 50 is composed of two beams 53 and 54 solidarised to each other by attachment means 55 and 56, so that the length of the beam 50 can be adjusted by varying the overlapping portion of the beams 53 and 54. However, other means could be used to make the same beam 50 adaptable to different vehicle models, for example such as a beam 50 made in a single part through which through holes are formed at different intervals corresponding to standard dimensions of vehicles to be fixed to the straightening bench. To fix a vehicle to the straightening bench, a beam 50 will be anchored to the left front and rear jack holes, while another beam 50 will be anchored to the right front and rear jack holes, after which said beams 50 can be used as a support to hold attachments of the straightening bench, and particularly jaws that will be able to firmly clamp said beams 50.

Therefore FIG. 6 and FIG. 7 represent two embodiments of the rods 60 and 70 used in the anchor kit according to the invention for the chassis of a vehicle. The rods 60 and 70 have different anchor heads 61 and 71 that correspond to different embodiments for use with different vehicle models. Not all vehicle models have identical jack support holes and therefore rods with adapted anchor heads are necessary.

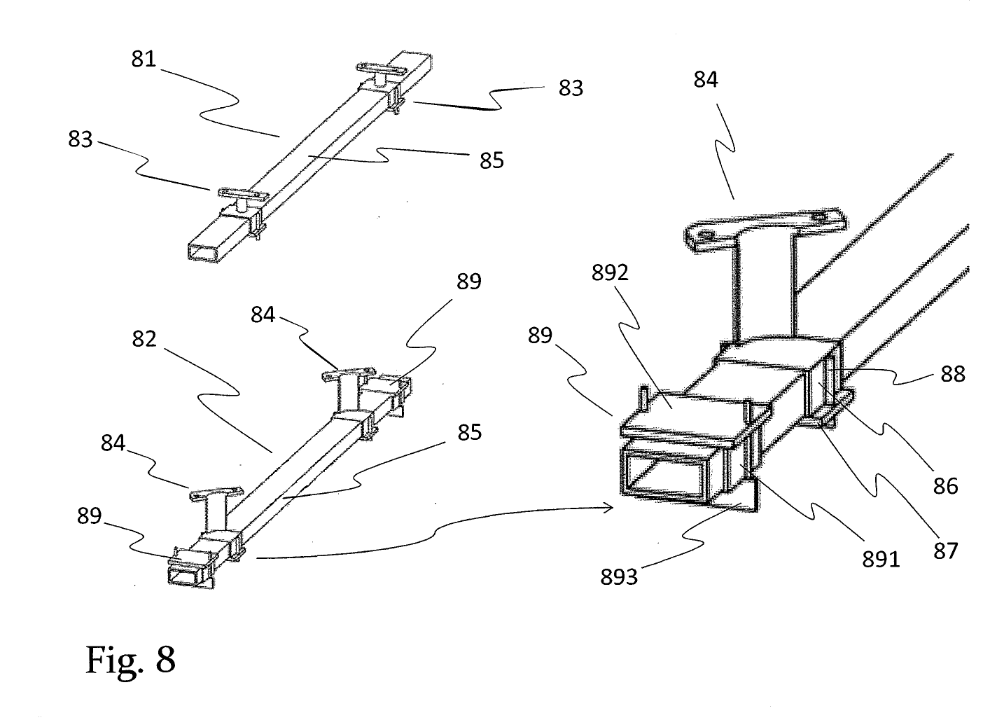

FIG. 8 represents beams 81, 82 for another embodiment of an anchor kit according to the invention. Such an anchor kit comprises beams 81, 82 that in this case are cross beams, one beam 81 being dedicated to the front part of the vehicle and another beam 82 to the rear part.

The beam 81 comprises anchor parts 83 that can be fixed to the vehicle chassis, advantageously using screws fixing the front cradle to the chassis to the vehicle, while the beam 82 comprises anchor parts 84 that can be fixed to the vehicle chassis, advantageously using screws fixing the rear axle of the vehicle to the vehicle chassis. Each of the beams 81 and 82 also comprises a rail 85. Each of said anchor parts 83 and 84 comprises a U-shaped part 86 free to slide on the rails 85, and also a closing plate 87 to fix said parts 83 and 84 to the rails 85, closing said U-shaped parts 86. Holes are formed in the closing plates 87 to fix the closing plates to rods 88 rigidly attached to lateral parts of U-shaped parts 86. The rods 88 may for example be threaded and fixed to the clamping plates 87 by means of bolts. The beams 81 and 82 also include attachment parts 89 (not shown on the beam 81 in FIG. 8) to hold attachments to the straightening bench, for example as described in FIG. 3. Such attachment parts 89 also comprise a U-shaped part 891 and a closing plate 892. The attachment parts 89 also include a clamping plate 893 that can be clamped by attachments of the straightening bench. Therefore, in this type of anchor kit, it is found that the anchor parts 83 and 84 are designed to be adapted to a specific vehicle model or even a category of models, while the rails 85 and attachment parts 89 can be used universally regardless of the model of the vehicle to be straightened Furthermore, the space between the anchor parts 83, 84, and the space between the attachment parts 89, can be fine adjusted by the operator, and are free to slide on the rail 85 before attachment, in order to adapt to specific features of the repaired vehicle and the straightening bench used. The anchor kit disclosed below is particularly advantageous due to its ease of assembly and the small number of parts to be designed specifically for a given vehicle model. As explained above, the rails 85 and the attachment parts 89 are universal and can be used regardless of the model of the vehicle to be fixed, which gives an indisputable economic advantage.

It is important to note that the different anchor kits for fixing to the chassis of a vehicle illustrated by FIG. 5-8 or the attachment described in FIG. 3 can equally well be used in combination with the straightening bench according to the invention and with any other type of straightening bench disclosed in prior art or more generally any other apparatus that has to be fastened to the chassis of a vehicle.

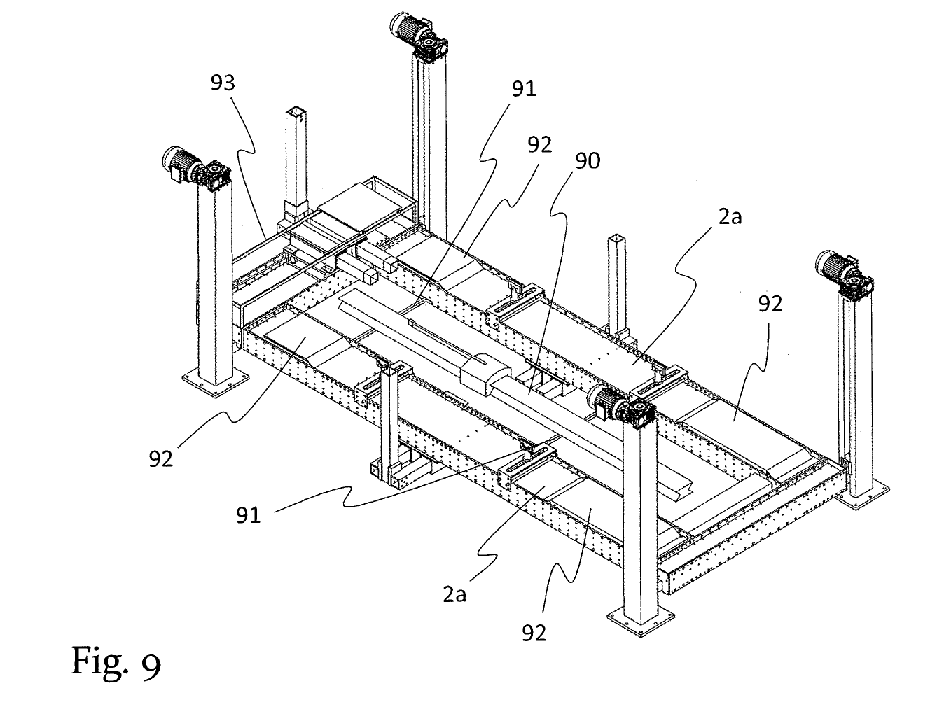

FIG. 9 represents an embodiment of the straightening bench according to the invention comprising a straight edge 90 acting as reference for a chassis measurement system, said straight edge 10 being fixed between said longitudinal beams 2a by means of cross beams 91 connecting the longitudinal beams 2a in pairs, plates 92 to measure the suspension geometry on the longitudinal beams 2a and a measurement instrument 93 for adjustment of the headlights on the front cross beam 2b of the straightening bench.

1. Straightening bench for the chassis and body of a vehicle, comprising:
An elevating platform comprising four beams, said four beams comprising two longitudinal beams and two cross beams connected in pairs, each of said cross beams being connected to two lifting columns,
Means of attachment of the vehicle to the longitudinal beams of the straightening bench, in which said attachment means can be fixed to a vehicle placed on its wheels on said longitudinal beams.

2. Straightening bench according to claim 1, wherein said attachment means can be fixed to the vehicle main beams or main beam stiffeners.

3. Straightening bench according to either claim 1, comprising at least one straightening bracket, said straightening bracket being attached to one of said four beams by removable attachment means.

4. Straightening bench according to claim 1, wherein said beams are I-beams, the central part of said beams being sufficiently wide so that a tyre of said vehicle can roll on it and lateral parts through which holes are formed at regular intervals.

5. Straightening bench according to claim 4, wherein the removable attachment means of the straightening bracket include rods inserted in holes in one of said I-beams.

6. Straightening bench according to either claim 4, comprising three straightening brackets, each of said straightening brackets being fixed onto a different I-beam.

7. Straightening bench according to claim 6, wherein rails are fixed to said I-beams, the straightening brackets being capable of sliding on said rails.

8. Straightening bench according to claim 6, wherein each straightening bracket comprises three hydraulic rams, each of said rams being capable of sliding in one of the three dimensions in space.

9. Straightening bench according to claim 1, comprising a hydraulic ram fixed to one of said four beams, said ram being capable of applying a vertical force on a point of the vehicle within the perimeter defined by said four beams.

10. Straightening bench according to claim 1, wherein said lifting columns comprise worm screws.

11. Straightening bench according to claim 1, comprising an ultrasound reception device for an ultrasound vehicle chassis measurement system, said ultrasound reception device being fixed to at least one of the beams of the straightening bench.

12. Straightening bench according to claim 1, wherein a system for measuring the geometry of the vehicle wheels is integrated into said longitudinal beams.

13. Straightening bench according to claim 1, wherein said attachment means comprise a degree of freedom in rotation about a rotation axis parallel to the plane formed by said four beams.

14. Straightening bench according to claim 1, wherein said attachment means comprise a degree of freedom in rotation about a rotation axis perpendicular to the plane formed by said four beams.

15. Anchor kit to the chassis of a vehicle for attachment for fastening to a straightening bench, comprising:
at least two rods, each rod comprising an anchor head for a jack support hole in said vehicle;
at least one beam comprising two through holes, the distance between said two through holes being equal to the distance between the support hole of the front jack support and the support hole of the rear jack support of said vehicle, the diameter of said through holes being sufficient to enable passage of said at least two rods;
attachment means to fix said at least one beam to at least two rods anchored to the chassis of the vehicle.

16. Anchor kit according to claim 15, wherein the at least one beam comprises means of varying the distance between said two through holes.

17. (canceled).

18. Attachment to fix a vehicle to a straightening bench comprising a rod a groove being machined at one end of said rod, said groove dividing the end of said rod into two legs, each of the two legs comprising a through hole, said two through holes facing each other and also comprising a first jaw, said first jaw being inserted in said groove, said first jaw comprising a through hole facing the through holes in the legs of said rod, and a second C-shaped jaw comprising a concave part, one leg of said rod being inserted in the concave part of said jaw, said jaws comprising a plurality of through holes facing each other in pairs, bolts being inserted in said through holes to fix the first jaw to said rod and to fix the second jaw to the first jaw.

19. Kit for anchorage to the chassis of a vehicle comprising a first cross beam dedicated to the front part of the vehicle, a second cross beam dedicated to the rear part of the vehicle, the first beam comprising anchor parts to the chassis of the vehicle, the second beam comprising anchor parts to the chassis of the vehicle, each of said first and second beams comprising a rail, said anchor parts comprising a U-shaped part and a closing plate to fix said anchor parts around said rails by closing said U-shaped parts, said beams also comprising attachment parts comprising a U-shaped part and a closing plate to fix said attachment parts around said rails by closing said U-shaped parts, the attachment parts also comprising a clamping plate that can be clamped by the attachment plates of a straightening bench.
